(19) United States
(12) Patent Application Publication
(10) Pub. No.: US 2026/0051588 A1
(43) Pub. Date: Feb. 19, 2026

(54) RECHARGEABLE BATTERY PACK

(71) Applicant: Robert Bosch GmbH, Stuttgart (DE)

(72) Inventors: Florian Schmehl, Ostfildern (DE); Marc-Alexandre Seibert, Stuttgart (DE)

(21) Appl. No.: 19/370,155

(22) Filed: Oct. 27, 2025

Related U.S. Application Data
(63) Continuation of application No. 17/051,563.

(30) Foreign Application Priority Data
May 4, 2018 (DE) 10 2018 206 883.6

(51) Int. Cl. H01M 50/213; H01M 10/42; H01M 10/46; H01M 50/247; H01M 50/528; H01M 50/548; H02J 7/00

(52) U.S. Cl. CPC H01M 50/213; H01M 10/425; H01M 10/46; H01M 50/247; H01M 50/528; H02J 7/0044; H01M 50/548; H01M 2220/30

(57) ABSTRACT

A rechargeable battery pack, in particular to an electrical contact apparatus for a rechargeable battery pack. The electrical contact apparatus includes a cell connector by way of which the electrical contact apparatus is electrically connectable to a battery cell, an electrical contact by way of which the electrical contact apparatus is connectable to a load and/or to a charging apparatus, and a flat connector for electrical and mechanical connection of the cell connector to the electrical contact. The cell connector is intermaterially connected in a first connecting region to the flat connector, and the flat connector is intermaterially connected in a second connecting region to the electrical contact. At least one intermaterial connection is effected using a welding process.

### RELATED APPLICATION INFORMATION

The present application is a continuation application of U.S. patent application Ser. No. 17/051,563, filed Oct. 29, 2020, which is a U.S. National Phase Application of International Patent Application PCT/EP2019/058776, filed Apr. 8, 2019, which claims priority to and the benefit of German Patent Application No. 10 2018 206 883.6, filed May 4, 2018, the disclosures of all of which are incorporated herein by reference.

### BACKGROUND INFORMATION

German Patent Application No. DE 20 2009 002 787 Ul describes a replaceable rechargeable battery pack for a handheld power tool, only one lithium ion rechargeable battery cell, which is received in a housing, being used.

### SUMMARY

The present invention relates to a rechargeable battery pack, in particular to an electrical contact apparatus for a rechargeable battery pack. In accordance with an example embodiment of the present invention, the electrical control apparatus has a cell connector by way of which the electrical contact apparatus is electrically connectable to a load and/or to a charging apparatus, an electrical contact by way of which the electrical contact apparatus is connectable to a load and/or to a charging apparatus, and a flat connector for electrical and mechanical connection of the cell connector to the electrical contact; the cell connector being intermaterially connected in a first connecting region to the flat connector, and the flat connector being intermaterially connected in a second connecting region to the electrical contact. In accordance with an example embodiment of the present invention, at least one intermaterial connection, in particular all intermaterial connections, is effected using a welding process. Advantageously, a rechargeable battery pack having particularly high performance can be realized by way of the electrical contact apparatus according to the present invention.

The rechargeable battery pack preferably has a rechargeable battery pack housing that is detachably connected, via a mechanical interface, to the load and/or to the charging apparatus. The rechargeable battery pack is preferably embodied as a replaceable rechargeable battery pack. The load can be embodied in particular as an outdoor power tool, for example a lawnmower or a hedge clipper, as a household appliance, for example an electric window cleaner or handheld vacuum cleaner, as a handheld power tool, for example an angle grinder, a power screwdriver, a drill, an impact drill, etc., or as a measurement tool, for example a laser distance measurer. It is also possible for the load to be embodied as a different, in particular portable, device, for example a worksite lighting system, an extraction device, or a worksite radio. The rechargeable battery pack is nonpositively and/or positively connectable to the load via the mechanical interface. Advantageously, the mechanical interface encompasses at least one actuation element by way of which the connection of the rechargeable battery pack to the load and/or to the charging apparatus is undoable. The rechargeable battery pack furthermore has at least one electrical interface by way of which the rechargeable battery pack is electrically connectable to the load and/or to the charging apparatus. The rechargeable battery pack can be, for example, charged and/or discharged via the electrical connection. Alternatively or additionally, it is also possible for information to be conveyable via the electrical interface. The electrical interface is preferably embodied as a contact interface in which the electrical connection is effected via a physical contact between at least two conductive components. The electrical interface preferably encompasses at least two electrical contacts. In particular, one of the electrical contacts is embodied as a positive contact and the other electrical contact as a negative contact. Alternatively or additionally, the electrical interface can have a secondary charging coil element for inductive charging. Also disposed in the rechargeable battery pack housing of the rechargeable battery pack is the at least one battery cell that is electrically connectable to the load via the electrical contact apparatus. The battery cell can be embodied as a galvanic cell that has a configuration in which one cell pole is located at one end, and a further cell pole at an oppositely located end. In particular, the battery cell has a positive cell pole at one end and a negative cell pole at an oppositely located end. The battery cells are preferably embodied as NiCd or NiMh battery cells, particularly preferably as lithium-based battery cells or lithium-ion battery cells. The rechargeable battery voltage of the battery cell as a rule is a multiple of the voltage of a single battery cell, and results from the connection (in parallel or serially) of the battery cells. In the context of commonplace battery cells having a voltage of 3.6 V, exemplifying battery voltages that result are therefore 3.6 V, 7.2 V, 10.8 V, 14.4 V, 18 V, 36 V, 54 V, 108 V, etc. The battery cell is preferably embodied as an at least substantially cylindrical round cell, the cell poles being disposed at the ends of the cylindrical shape. In addition, the electrical interface can have at least one additional contact that is embodied to transfer additional information to the load and/or to the charging apparatus. The rechargeable battery pack preferably has an electronics system; the electronics system can encompass a memory unit on which the information is stored. Additionally or alternatively, it is likewise possible for the information to be ascertained by the electronics system. The information can be, for example, a charge state of the rechargeable battery pack, a temperature within the rechargeable battery pack, a code, or a remaining capacity of the rechargeable battery pack. It is furthermore possible for the electronics system to be embodied to regulate or control the charging and/or discharging operation of the rechargeable battery pack. The electronics system can have, for example, a circuit board, a computation unit, a control unit, a transistor, a capacitor, and/or the memory unit. The electronics system can furthermore have one or several sensor elements, for example a temperature sensor for ascertaining the temperature within the rechargeable battery pack. Alternatively or additionally, the electronics system can have a coding element, for example a coding resistor.

The electrical contact apparatus is embodied in particular to electrically connect the battery cell to a load. The cell connector is embodied in particular for electrical connection of the electrical contact apparatus to the battery cell. Preferably a single cell connector is intermaterially connected to a single cell pole of the battery cell. Alternatively or additionally, the rechargeable battery pack can also have a cell connector that is intermaterially connected to more than one battery cell, for example two battery cells. The intermaterial connection of the battery cell to the cell connector is effected preferably by way of a welding process, for example a resistance welding process or a laser welding process. The electrical contact or contacts of the rechargeable battery pack are embodied in particular for nonpositive and/or positive connection to a corresponding contact element that is associated with the load or with the charging apparatus. The flat connector is preferably embodied from a sheet-metal element, preferably a stamped grid. A “connecting region” is to be understood in conjunction with this Application in particular as a region at which two materials are connected, in particular intermaterially, to one another. Preferably the materials abut against one another in the connecting region. Preferably the two materials are electrically connected to one another substantially via the connecting region. A “welding process” is to be understood in connection with this Application as a method in which two workpieces are intermaterially connected to one another with partial melting of at least one of the two workpieces. The electrical contact apparatus is advantageously intermaterially interconnected using a welding process and not using a soldering process, in order to achieve excellent mechanical stability and at the same time high electrical conductivity.

In accordance with an example embodiment of the present invention, it is furthermore provided that the first and the second connecting region be disposed at oppositely located ends of the flat connector. Advantageously, a compact rechargeable battery pack can be realized by way of this disposition. “Disposed at oppositely located ends” is to be understood in this connection to mean in particular that the connecting regions are spaced apart from one another by at least 70% of the length of the flat connector, preferably by at least 85% of the length of the flat connector. Preferably, the first and the second connecting region are disposed at oppositely located end-facing ends of the flat connector.

In accordance with an example embodiment of the present invention, it is further provided that the cell connector and the flat connector be made of the same material, in particular of a copper alloy or of ultra-pure copper. A “same material” is to be understood in particular as an identical material or identical substance. Advantageously, a rechargeable battery pack having high conductivity can thereby be realized. The copper alloy has in particular a copper concentration of at least 70%, preferably at least 858. The copper alloy can be embodied, for example, as a copper-tin alloy, as a copper-zinc alloy, as a copper-nickel alloy, etc. Alternative materials, for example CuZrCr and CuCrSiTi, are also possible. The ultra-pure copper is preferably embodied as low-oxygen ETP copper having a copper concentration of more than 99.98 or as oxygen-free copper (OFC) having a purity of more than 99.99%.

In accordance with an example embodiment of the present invention, it is also provided that the flat connector and the electrical contact be made of different materials. In particular, the material from which the flat connector is made has a higher electrical conductivity than the material from which the electrical contact is made. The material from which the flat connector is made preferably has a higher modulus of elasticity and/or a higher yield point than the material from which the electrical contact is made, Advantageously, the flat connector can thereby be optimized in terms of its electrical conductivity, and the electrical contact in terms of its mechanical properties.

In accordance with an example embodiment of the present invention, it is furthermore provided that a thickness of the flat connector in the first connecting region be greater than a thickness of the cell connector in the first connecting region. An optimal weld connection can thereby advantageously be achieved. In particular, the thickness of the flat connector corresponds to at least 1.5 times the thickness of the cell connector, preferably at least twice the thickness of the cell connector, by preference at least three times the thickness of the cell connector.

In accordance with an example embodiment of the present invention, it is further provided that a thickness of the electrical contact in the second connecting region be greater than a thickness of the flat connector. An optimal weld connection can thereby advantageously be achieved. In particular, the thickness of the electrical contact corresponds to at least 1.5 times the thickness of the flat connector.

In accordance with an example embodiment of the present invention, it is also provided that the electrical contact apparatus have at least one connecting means (connecting element) that is embodied to partly space the flat connector away from the cell connector, or the electrical contact away from the flat connector, adjacently to the connecting region. Advantageously, the welding process can thereby be optimized. The connecting means is preferably disposed in the connecting region. In particular, the connecting means constitutes the connecting region. Preferably, the connecting means is embodied in substantially single-point fashion, so that the flat connector abuts in substantially single-point fashion against the cell connector or against the electrical contact. The connecting means can be embodied, for example, as a dimple stamped into the material. The dimple is configured in particular in such a way that defined melting can be carried out during the welding operation. The dimple preferably has a defined cross section that is smaller than the cross section of the material in which the dimple is embodied.

In accordance with an example embodiment of the present invention, it is furthermore provided that the connecting means be embodied in one piece with the electrical contact apparatus. Advantageously, an economical electrical contact apparatus can thereby be realized. The connecting means is preferably produced using a process of forming a region of the electrical contact apparatus, preferably by compression forming, tension-compression forming, or tension forming.

In accordance with an example embodiment of the present invention, it is further provided that a width of the connecting means correspond to at most 50% of the width of the adjoining electrical contact apparatus, in particular at most 30% of the width of the adjoining electrical contact apparatus, preferably at most 15% of the width of the adjoining electrical contact apparatus. Advantageously, the welding process can thereby be further optimized. In this context, the “adjoining electrical contact apparatus” is to be understood as those components of the contact apparatus which are partly spaced away from the connecting means. In accordance with an example embodiment of the present invention, it is furthermore provided that a material thickness in the region of the connecting means be decreased, in particular decreased by at least 10%, preferably decreased by at least 20%.

The present invention furthermore relates to a single-cell rechargeable battery pack, in particular a handheld power tool rechargeable battery pack, having an electrical contact apparatus as described above, the rechargeable battery pack having a power output of more than 120 W, in particular more than 140 W. A system, made up of the single-cell rechargeable battery pack and a load, which is both compact and powerful can thereby advantageously be realized. A “single-cell rechargeable battery pack” is to be understood in particular as a rechargeable battery pack having a rechargeable battery pack housing in which only a single battery cell is received.

The present invention also relates to a method for manufacturing an electrical contact apparatus having at least two, preferably three, electrically conductive components, the method encompassing a method step in which the components are connected to one another using a resistance welding process and/or a laser welding process. In accordance with an example embodiment of the present invention, it is furthermore provided that in a further method step, a component of the electrical contact apparatus be deformed by application of force in order to manufacture a connecting means.

Alternatively, the present invention relates to a rechargeable battery pack, in particular to a handheld power tool rechargeable battery pack, having a battery cell, having a first electrical interface and a second electrical interface, the rechargeable battery pack being embodied to be dischargeable via the first electrical interface and chargeable via the second electrical interface. In accordance with an example embodiment of the present invention, it is provided that the interfaces be disposed separately from one another on the rechargeable battery pack. Advantageously, a particularly practical rechargeable battery pack that, for example, can be simultaneously charged and discharged can thereby be realized.

The first electrical interface and the second electrical interface are, in particular, embodied differently. Preferably the first electrical interface and the second electrical interface are embodied non-compatibly, in particularly not pin-compatibly. Preferably only the first electrical interface is connectable to the load, and only the second electrical interface is connectable to a charging apparatus. Alternatively, it is also possible for both electrical interfaces to be connectable only to different charging apparatuses, and for only one of the interfaces to be connectable to the load. The different charging apparatuses are preferably two charging apparatuses that differ in terms of the charging speed of the rechargeable battery pack. Alternatively, it is also possible that the rechargeable battery pack can be both discharged and charged via the first and the second electrical interface.

Preferably, neither the first electrical interface nor the second electrical interface is provided for inductive charging.

In accordance with an example embodiment of the present invention, it is furthermore provided that the first electrical interface have at least two electrical contacts, in particular at least two spring contacts, which preferably are disposed next to the battery cell. Advantageously, a higher discharge current can thereby be achieved. The electrical contacts can be associated, as already described above, with an electrical contact apparatus. “Two electrical contacts disposed next to the battery cell” is to be understood in particular to mean a physical disposition of the electrical contact in which a plane to which the longitudinal extent of the battery cells proceeds normally or perpendicularly intersects both the battery cell and the electrical contacts. Preferably, the plane intersects the electrical contacts completely in the region in which the electrical contacts participate in a connection to corresponding electrical contacts, for example of a load. In particular, the first interface and/or the second interface is disposed next to the battery cell. Preferably, both the electrical contact elements and the additional contacts are disposed next to the battery cell. Preferably, the first interface and/or the second interface, in particular the electrical contact elements, are disposed next to the battery cell in such a way that a length of the rechargeable battery pack is not increased by the placement of the first and/or second interface.

In accordance with an example embodiment of the present invention, it is further provided that the first electrical interface have at least one additional contact. Advantageously, further information can be transferred to the load and/or to the charging apparatus through the additional contact. The additional contact can be embodied, by way of example, as a coding contact for a charging apparatus, a coding contact for a load, or as a temperature contact for transferring temperature information of the rechargeable battery pack.

In accordance with an example embodiment of the present invention, it is also provided that the second electrical interface have a USB connector, in particular a USB-C connector or a USB Micro-B connector. Advantageously, the rechargeable battery pack can be charged particularly conveniently via a standardized connector.

In accordance with an example embodiment of the present invention, it is furthermore provided that the rechargeable battery pack encompass an electronics system having a circuit board, the first and/or the second electrical interface being disposed at least in part on the circuit board. Advantageously, a particularly compact rechargeable battery pack can thereby be realized. In accordance with an example embodiment of the present invention, it is further provided that the two electrical contacts be disposed at least in part between the circuit board and the battery cell.

In accordance with an example embodiment of the present invention, it is also provided that a longitudinal extent of the electronics system proceed substantially parallel to a longitudinal extent of the battery cell. Advantageously, the length of the rechargeable battery pack can thereby be kept particularly short. In accordance with an example embodiment of the present invention, it is furthermore provided that the longitudinal extent of the battery cell correspond substantially to the insertion direction of the rechargeable battery pack into the load.

In accordance with an example embodiment of the present invention, it is furthermore provided that the rechargeable battery pack be attachable, via a mechanical interface, detachably to a handheld power tool, such that in the attached state, charging of the rechargeable battery pack is possible in particular only via the second electrical interface.

Advantageously, a supply of power to the handheld power tool can thereby always be ensured. A “detachable” attachment is to be understood in this context in particular as an attachment that is detachable without tools.

In accordance with an example embodiment of the present invention, it is further provided that the rechargeable battery pack have a temperature sensor that is clamped between the electronics system and the battery cell, in particular between an electronics carrier made of plastic and the battery cell. Advantageously, simple assembly, and at the same time accurate determination of the temperature of the rechargeable battery pack in the region of the battery cell, can thereby be enabled. It is likewise possible for the rechargeable battery pack to have several temperature sensors in order to improve the temperature determination by way of redundancy.

The present invention furthermore relates to an assembly method for a rechargeable battery pack. In accordance with an example embodiment of the present invention, the following steps are carried out in the order recited:
connecting, in particular nonpositively and/or positively connecting, a first assembly module to a second assembly module, the first assembly module having a first electrical interface, a second electrical interface, and a temperature sensor on a circuit board of an electronics system, and the second assembly encompassing at least a part of an electrical contact apparatus on an electronics carrier;
establishing a welded connection, in particular at least two welded connections, between the first assembly module and the second assembly module, preferably between the first interface and the electrical contact apparatus.

Advantageously, particularly simple assembly of the rechargeable battery pack can thereby be realized.

In accordance with an example embodiment of the present invention, it is further provided that the assembly method additionally encompass the following step subsequently:
establishing a welded connection between the electrical contact apparatus and a battery cell.

In accordance with an example embodiment of the present invention, it is further provided that the assembly method additionally encompass the following steps subsequently:
receiving the welded-together components in an, in particular, cup-shaped rechargeable battery housing base element of a rechargeable battery pack housing;
closing off the rechargeable battery pack housing by way of a rechargeable battery cap.

Advantageously, the assembly method can thereby be further optimized.

The present invention furthermore relates to a rechargeable battery pack, in particular a handheld power tool rechargeable battery pack, having a rechargeable battery pack housing in which a battery cell and an electronics system are received. It is proposed that the electronics system have a control unit, a motion sensor and, in particular, a single light-emitting element, the control unit being embodied to control the light-emitting element, based on a signal detected by the motion sensor, to signal a charge state. Advantageously, the charge state of the rechargeable battery pack can thereby be displayed in a particularly convenient manner. In particular, thanks to the motion sensor a manually controllable operating element for the light-emitting element is not necessary. Alternatively or additionally, it is also possible for the control unit to be embodied for regulation, in particular for regulation of the light-emitting element.

The motion sensor is embodied in particular to convert a positional change of the rechargeable battery pack into an electrical variable and thus to ascertain a signal based on the positional change. The control unit encompasses at least one computation unit, for example a microprocessor, with which the signal of the motion sensor can be evaluated. Alternatively, it is likewise possible for the control unit to be embodied in analog fashion and to encompass, by way of example, at least one comparator. In particular, both the control unit and the motion sensor are embodied in analog fashion. The light-emitting element can be embodied as a monochrome light-emitting element or as a polychrome light-emitting element. In particular, the light-emitting element has at least one light-emitting diode. The light-emitting element preferably has at least two light-emitting diodes. The light-emitting element preferably has one light-emitting diode for each displayed color. Alternatively, it is also possible for the light-emitting element to be embodied as a multi-color LED.

In accordance with an example embodiment of the present invention, it is further provided that the motion sensor be embodied as an acceleration sensor. The motion sensor can be embodied in particular as a piezoelectric acceleration sensor. Advantageously, a precise measurement of the change in position can thereby be made possible. The acceleration sensor is preferably embodied as a MEMS component. The acceleration sensor can be embodied in particular to measure a linear acceleration along at least one axis, preferably along three axes. Alternatively, the acceleration sensor can be embodied to measure an angular velocity. It is also possible for the rechargeable battery pack to have more than one motion sensor, by way of example one for measuring a linear acceleration and one for measuring an angular velocity, in order to optimize ascertainment of the signal.

In accordance with an example embodiment of the present invention, it is also provided that the light-emitting element be embodied to emit light of different colors. The user can thereby advantageously be assisted in his or her work. In particular, the light-emitting element is embodied to emit light of three colors, the three colors being red, yellow, and green. Advantageously, intuitive use of the rechargeable battery pack can be achieved by that selection of colors. Alternatively, it would also be possible for the light-emitting element to be embodied to emit light of two colors, the two colors being red and green. Blue would also be possible in addition or alternatively to one of those colors. Alternatively, it is likewise possible, alternatively or additionally, for the intensity of the brightness of the active light-emitting element to be varied. The variation can occur, by way of example, linearly or exponentially.

In accordance with an example embodiment of the present invention, it is furthermore provided that the light-emitting element be embodied to emit light in continuous and/or flashing fashion. Displays to the user can thereby advantageously be further improved. In particular, the light-emitting element can be embodied to be partly flashing, “embodied to be partly flashing” being understood to mean that the light-emitting element emits light of at least one color in non-flashing fashion. The light-emitting element is embodied in particular to display a status of the charge state of the rechargeable battery pack. The status is ascertainable by the control unit based on the signal of the motion sensor. The status can be, by way of example, “rechargeable battery pack 100% charged,” “rechargeable battery pack 0% charged,” or “rechargeable battery pack charging.” Advantageously, a larger number of statuses than there are displayed colors can be implemented by way of the combination of light-emitting and flashing colors.

In accordance with an example embodiment of the present invention, it is further provided that the electronics system encompass a circuit board that is connected in particular to electrical contacts, the light-emitting element and the motion sensor being disposed on the circuit board. Advantageously, a compact rechargeable battery pack can thereby be realized. In particular, the motion sensor and the light-emitting element are embodied as surface-mounted components.

In accordance with an example embodiment of the present invention, it is also provided that the control unit be embodied to activate the light-emitting element upon detection of a motion of the rechargeable battery pack. Advantageously, the light-emitting element can thereby be activated by way of a motion of the rechargeable battery pack.

In accordance with an example embodiment of the present invention, it is furthermore provided that the control unit be embodied to activate the light-emitting element for a predetermined length of time that, in particular, depends on the charge state. Advantageously, energy consumption can thereby reduced. In particular, the control unit is embodied to activate the light-emitting element for a longer period of time in the context of an ascertainable first status that corresponds to a higher charge state than an ascertainable second status, than in the context of the second status.

In accordance with an example embodiment of the present invention, it is further provided that the control unit be embodied to switch off the light-emitting element upon discharging of the rechargeable battery pack. Advantageously, it is thereby possible to ensure that a reliable indication of the charge state is always ensured. “Discharging of the rechargeable battery pack” is to be understood in this context to mean in particular operation of the load, for instance screwdriving with a power screwdriver or grinding with a grinder. High currents flow in the context of such uses of the rechargeable battery pack, with the result that voltage drops sharply, and a charge state that is significantly too low is thereby ascertained.

In accordance with an example embodiment of the present invention, it is also provided that the rechargeable battery pack housing have a light guide, the light guide being embodied to direct, in particular to concentrate, outward the light proceeding from the light-emitting element. Advantageously, the light generated by the light-emitting element can thereby be efficiently directed outward from the interior of the rechargeable battery pack housing. The light guide is embodied in particular to be transparent. The light guide preferably has a light-collecting surface that is disposed to face toward the light-emitting element, and a light-radiating surface that is disposed on the outer surface of the rechargeable battery pack. The light-collecting surface can be disposed directly adjacently to the light-emitting element or abuttingly against the light-emitting element. In particular, the size of the light-collecting surface corresponds substantially to the size of the light-emitting element or to the area over which the light-emitting element emits light. The light-radiating surface preferably has a different geometric shape than the light-collecting surface. The light-radiating surface can have substantially the same size as the light-collecting surface. It is, however, also possible for the light-radiating surface to be smaller than the light-collecting surface in order to generate a higher light intensity.

In accordance with an example embodiment of the present invention, it is furthermore provided that the light guide be embodied in at least two stages, at least one stage being sealed by way of a sealing element. Advantageously, the rechargeable battery pack can thereby be effectively protected from liquid or moisture. A two-stage light guide has a first and a second light-guiding element, the light-guiding elements being connected to one another in such a way that light can transition from the first light-guiding element into the second light-guiding element. The light-guiding elements can be connected to one another nonpositively and/or positively, or intermaterially. Alternatively, it is also possible for the first light-guiding element to abut against the second light-guiding element, or for a small gap to be disposed between the two light-guiding elements.

The present invention further relates to a system encompassing a load and a rechargeable battery pack, the load being connectable detachably to the rechargeable battery pack, the rechargeable battery pack having a first and a second electrical interface, having a sealing apparatus for sealing the system with respect to the entry of dust and/or fluids. In accordance with an example embodiment of the present invention, it is provided that the sealing apparatus encompass a first sealing unit and a second sealing unit which are disposed between the first and the second electrical interface. Advantageously, the system can thereby be effectively protected from the entry of liquids or moisture. The sealing apparatus can be associated with the load and/or with the rechargeable battery pack. The sealing apparatus is embodied in particular in such a way that the system made up of a load and a rechargeable battery pack corresponds to an IP protection class of at least IPX3, preferably at least IPX4 and therefore protection from splashes (from any direction).

In accordance with an example embodiment of the present invention, it is also provided that the first sealing unit be embodied for sealing the first electrical interface. Advantageously, sealing of the first interface can thereby be ensured. In particular, the first sealing unit is disposed between the first electrical interface and a housing opening of the system. A “housing opening of the system” is to be understood in particular as an opening or a gap that is disposed between the rechargeable battery pack housing and a housing of the load when the load is in the connected state with the rechargeable battery pack.

In accordance with an example embodiment of the present invention, it is furthermore provided that the first sealing unit be disposed between the rechargeable battery pack housing of the rechargeable battery pack and the housing of the load. Advantageously, sealing can thereby be further improved.

In accordance with an example embodiment of the present invention, it is further provided that the first sealing unit have a two-part sealing element that is nonpositively and/or positively received by two housing shells of the housing. Advantageously, an inexpensive first sealing unit that is easily assembled can thereby be realized.

In accordance with an example embodiment of the present invention, it is also provided that the sealing element be manufactured by way of a multi-component injection molding process, in particular a two-component injection molding process, a radially internal part of the sealing element being embodied more elastically than a radially external part of the sealing element. Advantageously, a sealing element that is both elastic and mechanically stable can thereby be realized.

In accordance with an example embodiment of the present invention, it is furthermore provided that the second sealing unit be embodied to seal the rechargeable battery pack. In particular, the second sealing unit is disposed between the second electrical interface and the housing opening of the system.

In accordance with an example embodiment of the present invention, it is further provided that the rechargeable battery pack be embodied in at least two parts, the second sealing unit being disposed between a rechargeable battery pack base element and a rechargeable battery pack cap. Advantageously, the rechargeable battery pack can thereby be effectively sealed between its two housing parts. The rechargeable battery pack base element extends in its length, in particular, parallel to the longitudinal extent of the battery cells received in it. The rechargeable battery pack base element and the rechargeable battery pack cap are, in particular, nonpositively and/or positively connected to one another. In the state connected to the load, the rechargeable battery pack base element is, in particular, substantially surrounded by the housing of the load.

In accordance with an example embodiment of the present invention, it is also provided that the second sealing unit encompass a sealing ring. Advantageously, simple assembly and an economical sealing unit can thereby be realized.

In accordance with an example embodiment of the present invention, it is furthermore provided that the rechargeable battery pack housing have one or several openings, all the openings being closed off respectively by a closure element and being sealed respectively by way of a further sealing element. Advantageously, a substantially splash-protected rechargeable battery pack can thereby be realized. Preferably, in the unconnected state all the openings of the rechargeable battery pack, except for the first electrical interface, are protected from the entry of water.

The present invention furthermore proposes a rechargeable battery pack for a handheld power tool, having a sealing apparatus as described above; or a load, in particular a handheld power tool, having a first sealing unit as described above.

The present invention further relates to a rechargeable battery pack, in particular a handheld power tool rechargeable battery pack, having a rechargeable battery pack housing, the rechargeable battery pack housing having a rechargeable battery pack cap, encompassing a mechanical interface, for detachable connection of the rechargeable battery pack housing to a load, the mechanical interface having at least one resilient latching element. In accordance with an example embodiment of the present invention, it is provided that the rechargeable battery pack cap have an internal housing part and an external housing part, the latching element being disposed on the inner housing part and an operating element being disposed on the external housing part. The operating element is embodied in particular for actuation of the latching element, so that the latching element can be brought into and/or out of engagement by way of an application of force onto the operating element. The advantageous result that can be achieved by embodying the operating element and the latching element in different housing parts is that the operating element is optimally adapted for a user, and the latching element is designed for optimum connection.

In accordance with an example embodiment of the present invention, it is also provided that the internal housing part encompass the mechanical interface, and that the external housing cover at least one gap of the internal housing part. Advantageously, the system made up of a load and a rechargeable battery pack can thereby be effectively protected, in the connected state, from the entry of dust and liquids.

The mechanical interface is embodied in particular for nonpositive and/or positive connection. The mechanical interface preferably has means that are associated with the rechargeable battery pack, and means that are associated with the load. The resilient latching element is embodied in particular as a resilient latching arm. The resilient latching arm is preferably embodied in one piece with the internal housing part. The external housing part is disposed, with respect to the internal housing part, in particular radially externally with respect to the longitudinal extent.

The external housing part is preferably embodied as an outer housing. The internal housing part is, by preference, not disposed on the outer surface of the rechargeable battery pack cap.

In accordance with an example embodiment of the present invention, it is also provided that the gap be embodied adjacently to the latching element. Advantageously, the elastic properties of the latching arm can be optimally adapted by way of the gap. In particular, two gaps are disposed adjacently to each latching arm of the mechanical interface. In accordance with an example embodiment of the present invention, it is furthermore provided that the gap be disposed between two latching arms in a circumferential direction. In accordance with an example embodiment of the present invention, it is further provided that the gap extend substantially parallel to a longitudinal extent of the rechargeable battery pack. Preferably, the longitudinal extent of the rechargeable battery pack is embodied to be parallel to an insertion direction or introduction direction of the rechargeable battery pack in the process of connection to the load. It is also possible for the longitudinal extent of the rechargeable battery pack to correspond substantially to the longitudinal extent of the battery cells. A length of the latching arm can correspond substantially to a length of the gap. It is, however, also possible for the length of the latching arm to be greater than the length of the gap.

In accordance with an example embodiment of the present invention, it is also provided that the internal housing part encompass an operating region and a coupling region, the operating region being, in particular, completely covered by the external housing part. An “operating region” is to be understood in particular as a region of the internal housing part that, in response to an application of force, becomes deformed and/or bent in such a way that the latching arm is moved. The operating region is preferably disposed in such a way that it is actuatable both in the state connected to the load and in the unconnected state. The rechargeable battery pack connected to the load is preferably detachable toollessly from the load, by way of an application of force onto the operating region. The coupling region is embodied in particular to establish the nonpositive and/or positive connection to a corresponding means of the load. In the state connected to the load, the coupling region is in particular surrounded by the housing of the load. It is furthermore proposed that the coupling region be devoid of the external housing part. In particular, the operating element is disposed in the operating region. Preferably the operating region is constituted by the operating element.

In accordance with an example embodiment of the present invention, it is further provided that the internal housing part and the external housing part be embodied from different materials. In accordance with an example embodiment of the present invention, it is also provided that the internal housing part be embodied from a hard plastic, and the external part from a soft plastic. In particular, the internal housing part has a higher modulus of elasticity than the external housing part. A secure connection via the latching arm can be ensured by way of the stiffer internal housing part. Advantageously, an improved user interaction can be implemented by way of the softer external housing, since the rechargeable battery pack cap can be more securely gripped thanks to the softer material. The rechargeable battery pack furthermore, as a result of the softer material of the external housing, advantageously has improved elastic properties that can absorb the energy that acts on the rechargeable battery pack in the event of a fall.

In accordance with an example embodiment of the present invention, it is furthermore provided that a ratio of a material thickness of the internal housing part and a material thickness of the external housing part not exceed on average a value of substantially 3, in particular on average a value of substantially 2, preferably a value of substantially 1. Advantageously, the advantages of the individual housing parts can be optimally utilized in this range. The material thickness of the internal housing part is, in this context, greater than the material thickness of the external housing part.

In accordance with an example embodiment of the present invention, it is further provided that the external housing part have an operating means (operating element). The operating means is embodied in particular as an outer surface of the operating element. Advantageously, operation of the rechargeable battery pack can be facilitated by the operating means. The operating means can be embodied in one piece with the external housing part. The operating means can be embodied as a surface modification of the external housing part. In particular, the operating means is disposed above the operating region of the internal housing part. Advantageously, this ensures that the application of force onto the rechargeable battery pack occurs at the correct site. The surface modification can encompass, for example, ribs and/or nubs that extend inward or outward.

The present invention also relates to a method for manufacturing a rechargeable battery pack cap as described above, the rechargeable battery pack cap being manufactured by way of a multi-component injection molding process, in particular a two-component injection molding process. Advantageously, economical manufacture of the rechargeable battery pack cap can be realized thanks to this feature.

### BRIEF DESCRIPTION OF THE DRAWINGS

Further advantages are evident from the description below of the figures. The figures and the description contain numerous features in combination. One skilled in the art will also appropriately consider the features individually, and group them together into further useful combinations.

FIG. 1 is a side view of a system having a load and a rechargeable battery pack, in accordance with an example embodiment of the present invention.

FIG. 2 is a perspective view of the rechargeable battery pack according to FIG. 1, in accordance with an example embodiment of the present invention.

FIG. 3a is a perspective view of an electrical contact apparatus and a battery cell of the rechargeable battery pack according to FIG. 2, in accordance with an example embodiment of the present invention.

FIG. 3b is a lateral section through the electrical contact apparatus according to FIG. 3a, in accordance with an example embodiment of the present invention.

FIG. 3c is a cross section through the electrical contact apparatus according to FIG. 3b, in accordance with an example embodiment of the present invention.

FIG. 4 is a cross section of an alternative embodiment of an electrical contact apparatus, in accordance with an example embodiment of the present invention.

FIG. 5a is a perspective view of a first assembly module, in accordance with an example embodiment of the present invention.

FIG. 5b is a perspective view of a second assembly module, in accordance with an example embodiment of the present invention.

FIG. 5c is a perspective view of the first assembly module connected to the second assembly module and to the battery cell, in accordance with an example embodiment of the present invention.

FIG. 6 is a partial longitudinal section through the system according to FIG. 1, in accordance with an example embodiment of the present invention.

FIG. 7 is a perspective view of a light guide, in accordance with an example embodiment of the present invention.

FIG. 8 is a perspective view of a first sealing unit, in accordance with an example embodiment of the present invention.

FIG. 9 is a perspective view of a rechargeable battery pack cap, in accordance with an example embodiment of the present invention.

### DETAILED DESCRIPTION OF EXAMPLE EMBODIMENTS

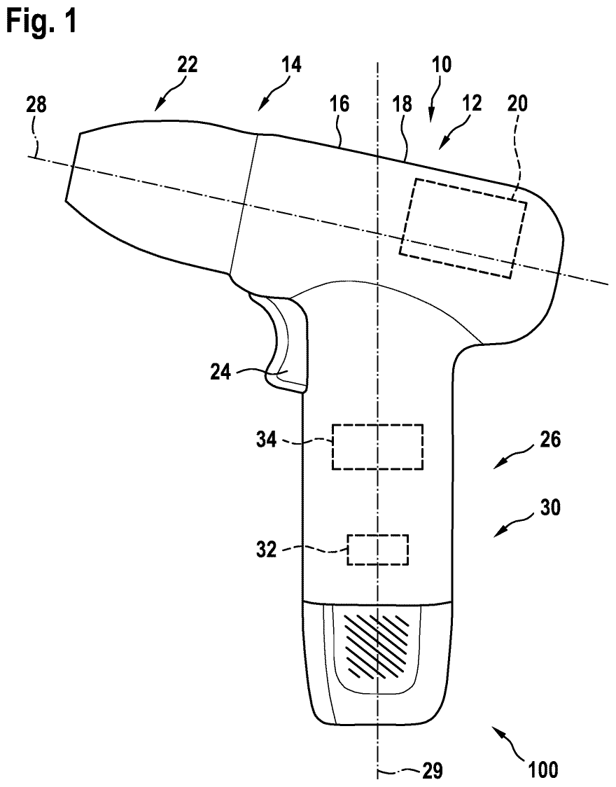

FIG. 1 shows a system according to the present invention made up of a load 10 and a rechargeable battery pack 100. Load 10 is embodied by way of example as a handheld power tool 12, in particular as a power screwdriver. Handheld power tool 12 has a housing 14 that encompasses at least a first housing shell 16 and a second housing shell 18. The two housing shells 16, 18 can be connected to one another, by way of example, via a screw connection. A drive unit 20 having an electric motor is disposed in housing 14 of handheld power tool 12. Drive unit 20 is coupled, in particular via a transmission unit, to a tool receptacle 22. Tool receptacle 22 is embodied to receive an application tool (not depicted) in such a way that a drive motion proceeding from drive unit 20 is transferrable to the application tool. Handheld power tool 12 furthermore has an operating switch 24 for switching handheld power tool 12, or drive unit 20, on and off. Operating switch 24 is disposed on a handle 26 that extends obliquely with respect to a working axis 28. A “working axis” is to be understood in this context in particular as an axis around or along which the application tool is driven during operation. Handle 26 extends obliquely with respect to working axis 28. In particular, working axis 28 and longitudinal axis 29 of handle 26 enclose an angle of more than 90°. Drive unit 20 and tool receptacle 22 are disposed at the upper end of handle 26. Disposed at the lower end of handle 26 is a rechargeable battery pack receptacle 30 that is provided for reception of rechargeable battery pack 100. Rechargeable battery pack 100 is received in part, in particular for the most part, in handle 26. Rechargeable battery pack receptacle 30 encompasses two latching pockets 32 and an electrical interface 34.

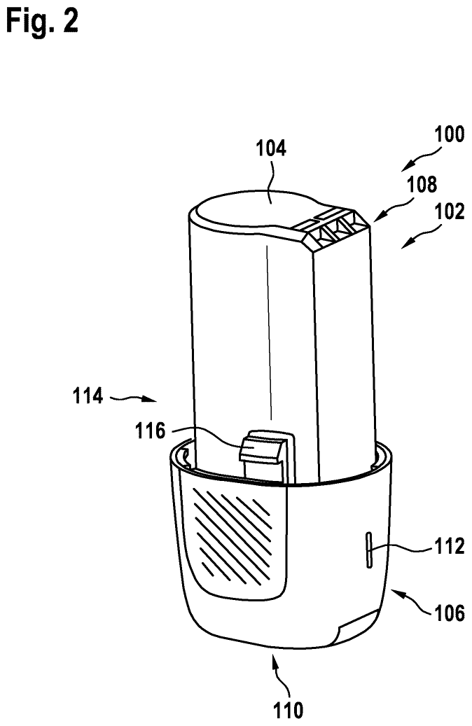

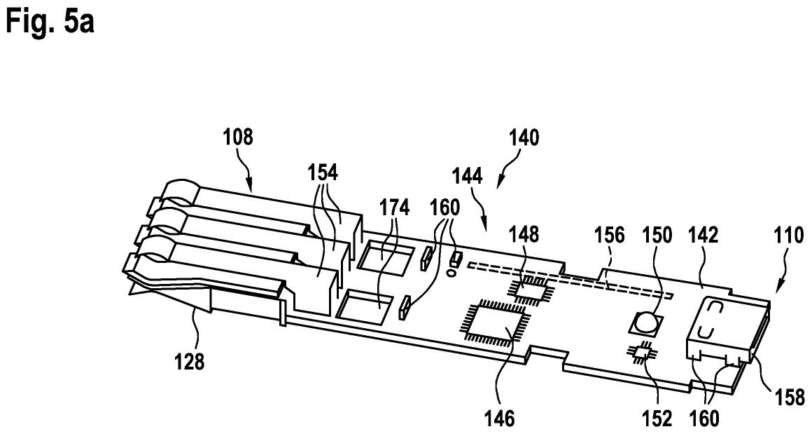

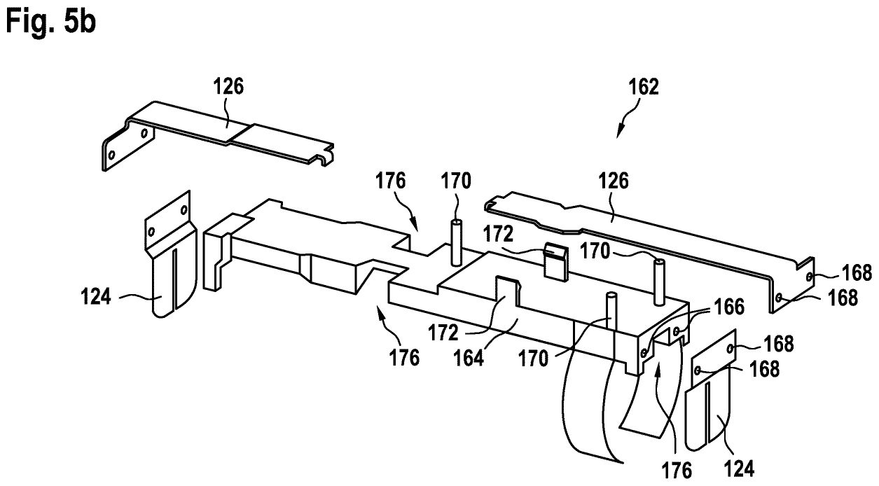

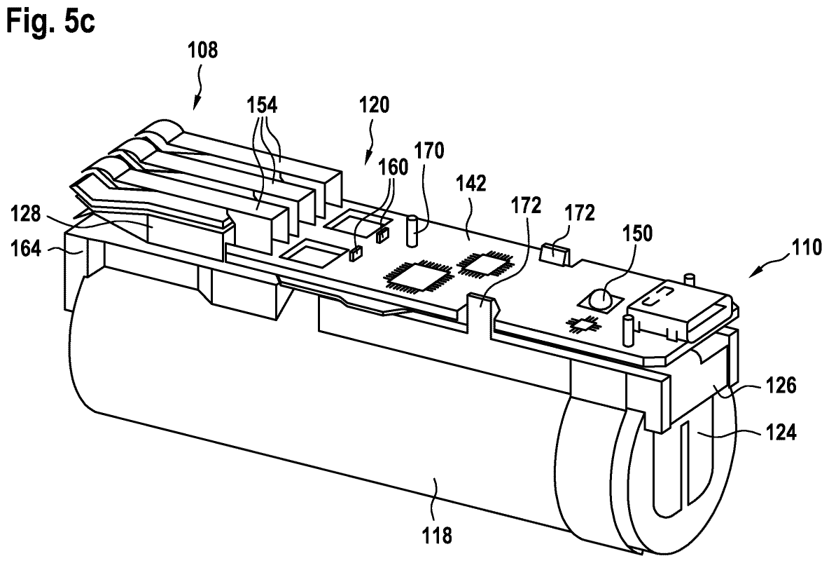

Rechargeable battery pack 100 is embodied in particular as an insertion-type rechargeable battery pack that, in the state connected to handheld power tool 12, is received in part in rechargeable battery pack receptacle 30 of handheld power tool 12. In particular, rechargeable battery pack 100 is embodied as a replaceable rechargeable battery pack. A perspective view of rechargeable battery pack 100 is shown in FIG. 2. Rechargeable battery pack 100 is provided in order to supply energy to load 10 or to handheld power tool 12. In particular, rechargeable battery pack 100 is partly surrounded by housing 14 of handheld power tool 12. In the region in which rechargeable battery pack 100 is surrounded by housing 14, rechargeable battery pack 100 is preferably completely surrounded in a circumferential direction. Rechargeable battery pack 100 is embodied as a handheld power tool rechargeable battery pack. Rechargeable battery pack 100 has a rechargeable battery pack housing 102 that is embodied in multiple parts. Rechargeable battery pack housing 102 has a cup-shaped rechargeable battery pack base element 104 and a rechargeable battery pack cap 106. In particular, rechargeable battery pack cap 106 closes off rechargeable battery pack base element 104. Rechargeable battery pack 100 has a first electrical interface 108 that is embodied to electrically connect rechargeable battery pack 100 to handheld power tool 12, in particular to electrical interface 34 of handheld power tool 12. First electrical interface 108 is disposed at a first end of rechargeable battery pack 100. In particular, first electrical interface 108, in the state connected to handheld power tool 12, is received completely in housing 14 of handheld power tool 12. Rechargeable battery pack 100 furthermore has a second electrical interface 110 (see FIG. 5a). Second electrical interface 110 is embodied, in particular, for connection to a charging apparatus (not depicted). It is possible to connect electrical interface 110 to the charging apparatus directly, or alternatively also via a cable connection. Second electrical interface 110 is disposed at a second end of rechargeable battery pack 100 which is located oppositely from the first end. Rechargeable battery pack 100 has a charge state display 112 by way of which the charge state of rechargeable battery pack 100 can be displayed. Charge state display 112 is disposed on rechargeable battery pack cap 106. Charge state display 112 is preferably disposed on a side of rechargeable battery pack 100 facing away from the tool receptacle. Rechargeable battery pack 100 furthermore encompasses a mechanical interface 114 that is embodied for detachable attachment of rechargeable battery pack 100 on handheld power tool 12. Mechanical interface 114 encompasses two latching elements 116, embodied as resilient latching arms 116, which extend toward handheld power tool 12. Latching arms 116 are receivable in latching pockets 32 of handheld power tool 12 for nonpositive and positive connection. Rechargeable battery pack 100 encompasses a single battery cell 118 that is disposed in rechargeable battery pack housing 102.

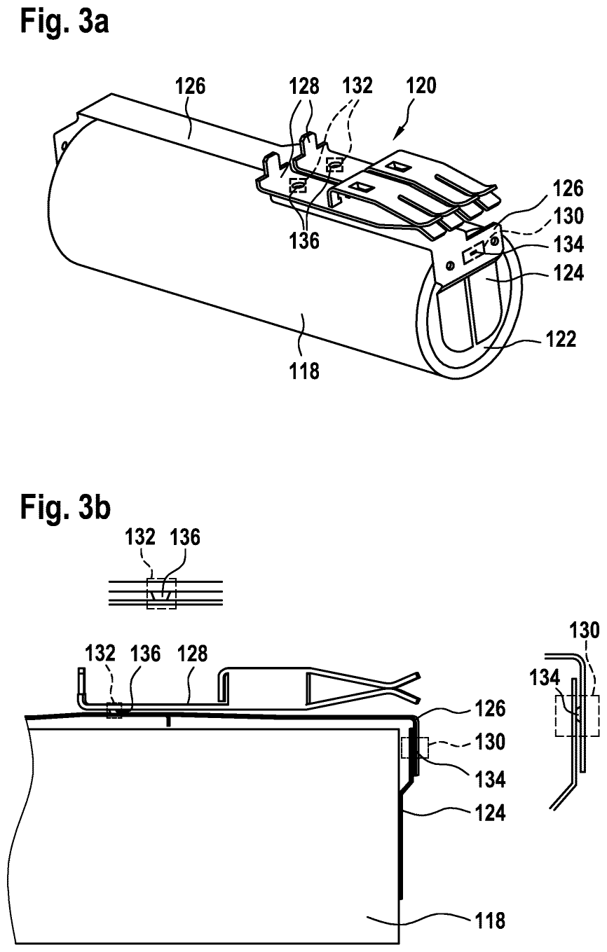

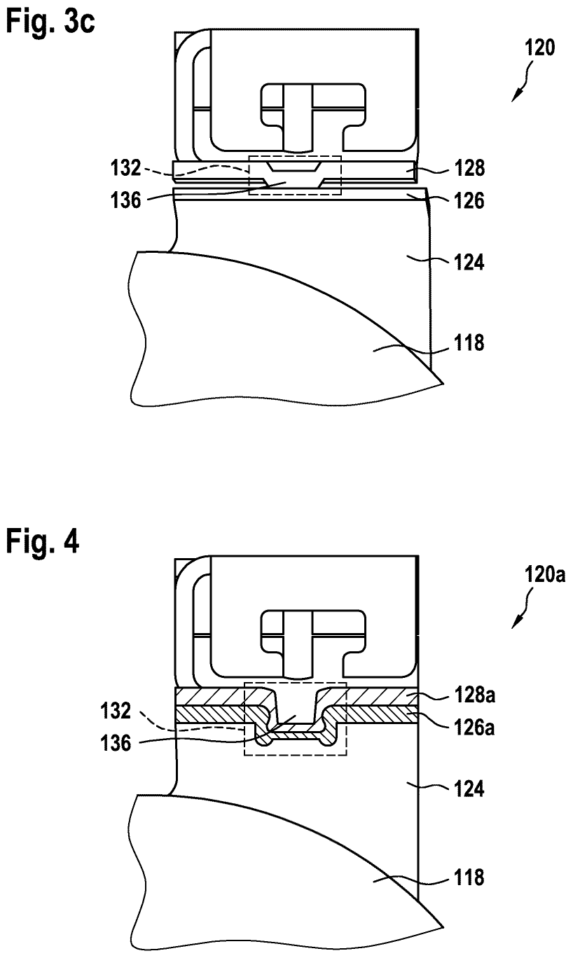

FIG. 3a is a perspective view of an electrical contact apparatus 120 and a battery cell 118. FIG. 3b shows electrical contact apparatus 120 and battery cell 118 in a longitudinal section. Battery cell 118 has two cell poles 122 that are disposed at the ends. Electrical contact apparatus 120 has two cell connectors 124 that are embodied to establish an electrical connection between electrical contact apparatus 120 and battery cell 118, in particular one of cell poles 122 of battery cell 118. Electrical contact apparatus 120 furthermore has two flat connectors 126 that are embodied to connect cell connectors 124 respectively to an electrical contact 128. Alternatively, it is also possible for electrical contact apparatus 120 to have respectively only one cell connector 124, one flat connector 126, and one electrical contact 128. Electrical contacts 128 are embodied as sheet-metal spring contacts. A high-performance battery cell 118 is needed in order to supply a high-performance load 10, such as handheld power tool 12, with sufficient power using a one-cell rechargeable battery pack 100. It is additionally necessary to ensure that electrical contact apparatus 120, which electrically connects battery cell 118 to load 10 or to electrical interface 34 of handheld power tool 12, meets the requirements of such high currents. For that reason, soldered connections are avoided in the context of connecting the individual components of electrical contact apparatus 120. Cell connectors 124 are intermaterially connected to flat connectors 126, in a respective first connecting region 130, using a welded connection. The welded connection is preferably effected using a resistance welding process, although it is likewise possible for the welded connection to be established using a laser welding process. Electrical contacts 128 are intermaterially connected to flat connectors 126, respectively via a second connecting region 132, via a welded connection. That welded connection is likewise effected using a resistance welding process. Alternatively, it would be possible here as well to establish the intermaterial connection using a laser welding process. Cell connectors 124 and flat connectors 126 are embodied from ultra-pure copper in order to ensure very high conductivity. Cell connectors 124 have a thickness of approx. 0.1 mm, and flat connectors 126 have a thickness of 0.3 mm. Electrical contacts 128 are embodied from a copper alloy that has both high conductivity and a certain elasticity. Electrical contacts 128 have a thickness of 0.5 mm. In particular, the conductivity of the material of flat connectors 126 and of cell connectors 124 is higher than the conductivity of the material of electrical contacts 128.

As is evident from FIG. 3b, flat connector 126 abuts, in first connecting region 130, against cell connector 124 via a connecting means (connecting element) 134. In connecting region 130, flat connector 126 and the cell connector are, in particular, disposed overlappingly with respect to the longitudinal extent of rechargeable battery pack 10. “Disposed overlappingly” is to be understood in this context to mean in particular that a plane for which the longitudinal extent of rechargeable battery pack 10 constitutes the normal intersects both flat connector 126 and cell connector 124. Connecting means 134 is embodied in one piece with flat connector 126, although it would also be possible to embody connecting means 134 in one piece with cell connector 124. Connecting means 134 is preferably produced by processing flat connector 126 by way of a forming process. Connecting means 134 is preferably produced by tension-compression forming, in particular deep drawing. Connecting means 134 is embodied in rib-shaped or elongated fashion, and extends into the space between flat connector 126 and cell connector 124. Alternatively, it would also be possible to embody connecting means 134 in dimple-shaped fashion. As a result of the abutment of connecting means 134, flat connector 126 and cell connector 124 are at least partly spaced away from one another adjacently to connecting means 134, so that a gap is produced. Advantageously, in the context of the welding process, the intermaterial connection via connecting means is introduced locally in order to achieve an optimum spot weld.

Electrical contact 128 also abuts, via a further connecting means (further connecting element) 136 in second connecting region 132, against flat connector 126. Further connecting means 136 is embodied in one piece with electrical contact 128, although here as well it is possible to embody connecting means 136 in one piece with flat connector 126. Further connecting means 136 can be produced using a forming process. Further connecting means 136 is embodied in an oval shape, in particular a circular shape.

FIG. 3c is a cross section through electrical contact apparatus 120 and battery cell 118. The cross section extends through second connecting region 132. Further connecting means 136, produced by the forming of electrical contact 128, has a thickness that is approximately 10% less than the thickness of electrical contact 128 before processing using the forming process. Electrical contact 128 formed from a metal sheet thus has a greater material thickness adjacently to further connecting means 136 than in second connecting region 132. The same is correspondingly true for connecting means 134 in first connecting region 130. The width of further connecting means 136, and thus the width of second connecting region 132, corresponds substantially to 25% of the width of electrical contact 128.

FIG. 4 shows an alternative embodiment of electrical contact apparatus 120a, in which the connection of the individual components of electrical contact apparatus 120a is accomplished at least in part not by way of a welding process. It shows a cross section through a second connecting region 132a in which an electrical contact 128a is substantially positively connected to a flat connector 126a. The connection can be produced, by way of example, using a clinching process, for example clinching, punch riveting, or clinch riveting. In the clinching process, firstly the two workpieces to be connected to one another are placed on top of one another, and the two workpieces are then deformed together, using a punch (not depicted) that in particular is shaped concavely, in such a way that a positive connection is produced. The method can be gathered, for example, German Patent Application No. DE 10 2008 025 074 A1. Advantageously, with the clinching process it is possible to achieve, with no additional materials, a sheet-metal connection that connects the materials both mechanically and electrically to one another, and in which the influence on electrical conductivity is minimal.

The assembly process for rechargeable battery pack 100 is explained in further detail with reference to FIGS. 5a to 5c. FIG. 5a is a perspective depiction of a first assembly module 140. Firstly, first assembly module 140 is assembled. First assembly module 140 encompasses a circuit board 142 of an electronics system 144, on which a control unit 146 (encompassing a computation unit), a memory unit 148, a light-emitting element 150, and a motion sensor 152 are disposed. Circuit board 142 extends substantially parallel to battery cell 118 or to the longitudinal extent of battery cell 118. Located at a first end of circuit board 142 is first electrical interface 108, encompassing two electrical contacts 128 and three additional contacts 154 that are disposed above electrical contacts 128. Disposed between electrical contacts 128 and additional contacts 154 is a non-conductive spacer, which is produced in particular from a plastic, for electrically insulating electrical contacts 128 from additional contacts 154. Additional contacts 154 are embodied to transfer information to load 10 and/or to a charging apparatus. In particular, one of additional contacts 154 is embodied as a coding contact for a load 10, through which information regarding rechargeable battery pack 100, for example the charge state, or characteristics of rechargeable battery pack 100, for instance the maximum and/or available capacity, is transferrable. A further additional contact 154 can be embodied as a coding contact for a charging apparatus, by way of which information regarding rechargeable battery pack 100, or characteristics of rechargeable battery pack 100, for instance maximum and/or available capacity, are transferrable. A further additional contact 154 is embodied to convey temperature information, which is detected via a temperature sensor, to load 10 or to a charging apparatus. Second electrical interface 110 is disposed at an oppositely located second end of circuit board 142. Control unit 146, memory unit 148, light-emitting element 150, and motion sensor 152 are disposed on the same side of circuit board 142. A temperature sensor 156 also extends along that side of circuit board 142 which is located oppositely from control unit 146. Temperature sensor 156 is embodied in particular to detect a parameter by way of which a temperature of battery cell 118 and/or of rechargeable battery pack 100 is ascertainable. Second electrical interface 110 is embodied as a USB connector 158. Electrical contacts 128, additional contacts 154, USB connector 158, and temperature sensor 156 are connected intermaterially via a soldered connection, and additionally nonpositively and/or positively, to the circuit board. The circuit board in particular has connecting elements 160 in the form of recesses into which electrical contacts 128, additional contacts 154, temperature sensor 156, and USB connector 158 positively engage.

FIG. 5b shows a second assembly module 162. Second assembly module 162 encompasses an electronics carrier 164 that is constituted from a plastic. Second assembly module 162 furthermore encompasses cell connectors 124 and flat connectors 126 of electrical contact apparatus 120. Electronics carrier 164 has assembly elements 166 by way of which electronics carrier 164 is nonpositively and/or positively connectable to cell connectors 124 and to flat connectors 126. Assembly elements 166 are embodied in one piece with electronics carrier 164. Assembly elements 166 protrude in stud-like fashion from electronics carrier 165. Cell connectors 124 and flat connectors 126 have corresponding assembly elements 168. The corresponding assembly elements 168 are embodied as circular cutouts. One of assembly elements 166 of electronics carrier 164 is advantageously positively connectable to an assembly element 168 of cell connector 124 and to an assembly element 168 of flat connector 126, thereby making possible particularly simple assembly of second assembly module 162.

In a first method step, first assembly module 140 and second assembly module 162 are nonpositively and/or positively connected to one another. Electronics carrier 164 has stud-shaped positive engagement elements 170 and latch elements 172 which can be connected or brought into engagement with corresponding cutouts in circuit board 142. Positive engagement elements 170 and latch elements 172 are embodied in one piece with electronics carrier 164. First assembly module 140 and second assembly module 162 are thus connected to one another via a latching connection.

In a second method step, the individual components of electrical contact apparatus 120 are intermaterially connected to one another. The intermaterial connection is effected using a resistance welding process. First assembly module 140, in particular circuit board 142 of electronics system 144, has a weld cutout 174 adjacently to second connecting region 136 of electrical contact apparatus 120. Second assembly module 162, in particular electronics carrier 164, has at least one respective weld cutout 176 adjacently to first connecting region 130 and adjacently to second connecting region 132 of electrical contact apparatus 120. With first assembly module 140 and second assembly module 162 in the state connected to one another, connecting regions 130, 134 of the electrical contact apparatus are thus advantageously embodied to be exposed at least on one side, in particular on both sides. The intermaterial connection can thereby be implemented using a resistance welding process or a laser welding process.

In a further method step, battery cell 118 is placed between the two cell connectors 124 (see FIG. 5c). Battery cell 118 is positioned in such a way that temperature sensor 156 becomes clamped between battery cell 118 and electronics system 144, in particular circuit board 142 of electronics system 144. Electrical contact apparatus 120, in particular cell connector 124, is intermaterially connected to battery cell 118. The intermaterial connection is effected once again using a resistance welding process. Alternatively, however, it is also possible to use a laser welding method. First assembly module 140, and second assembly module 162 having battery cell 118, are then received in rechargeable battery pack housing 102.

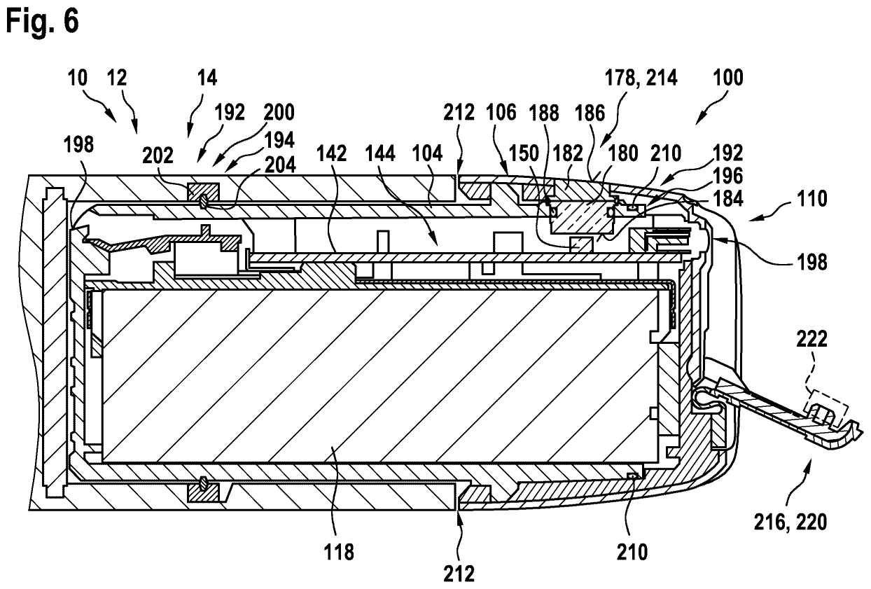

FIG. 6 is a longitudinal section through rechargeable battery pack 100 received in handheld power tool 12. In order to implement a rechargeable battery pack 100 that is axially as compact as possible, first interface 108, second interface 110, and electronics system 144 are disposed next to battery cell 118. In particular, first and/or second electrical interface 108, 110 axially terminates substantially with battery cell 118. “Axially terminates substantially with battery cell 118” is to be understood in this context in particular to mean that first and/or second electrical interface 108, 110 projects beyond battery cell 118 no farther than 20% of the length of battery cell 118, preferably no farther than 10% of the length of battery cell 118, by preference no farther than 5% of the length of battery cell 118. Motion sensor 152, disposed on circuit board 142 of electronics system 144, is connected via control unit 146 to light-emitting element 150. Motion sensor 152 is embodied in particular to detect a motion parameter that, by way of example, corresponds to a velocity, to an acceleration, or to an angular velocity, or by way of which one of those variables can be determined. Motion sensor 152 is embodied as an, in particular, three-axis acceleration sensor. Motion sensor 152 conveys the motion parameter to control unit 146. Control unit 146 is embodied to ascertain a motion state based on the motion parameter of motion sensor 152. The motion state can be, by way of example, a stationary or a moving state of rechargeable battery pack 100 and/or of the system made up of load 10 and rechargeable battery pack 100. Alternatively or additionally, it is also possible for control unit 146 to ascertain, by way of the motion parameter of motion sensor 152 and/or by way of a current parameter, whether the system is in a working state. The current parameter can be, for example, a discharge current of rechargeable battery pack 100 which is detectable by electronics system 144. In the working state, load 10 is driven using energy that is made available by rechargeable battery pack 100. Electronics system 144, in particular control unit 146, is furthermore embodied to ascertain the charge state of battery cell 118 or of rechargeable battery pack 100.

Control unit 146 controls light-emitting element 150 based on the motion state and the charge state. Light-emitting element 150 has three light-emitting diodes: a red light-emitting diode, a green light-emitting diode, and a yellow light-emitting diode. Light-emitting element 150 becomes activated when a motion state that corresponds to a moving state is ascertained by control unit 146. If the charge state in that context corresponds to a high charge state, for example 40% to 100% of the maximum charge state, light-emitting element 150 is then controlled in such a way that light-emitting element 150 emits green light. If the charge state corresponds to a medium charge state, for example 20% to 40% of the maximum charge state, light-emitting element 150 is then controlled in such a way that light-emitting element 150 emits yellow light. If the charge state corresponds to a low charge state, for example 5% to 20% of the maximum charge state, light-emitting element 150 is then controlled in such a way that light-emitting element 150 emits red light. In all three of the above charge states, light-emitting element 150 emits light continuously. If the charge state corresponds to a minimum charge state, for example 0 to 5% of the maximum charge state, light-emitting element 150 is then controlled in such a way that light-emitting element 150 emits flashing red light. In the event of a change in the motion state from a moving to a stationary state, light-emitting element 150 is not immediately deactivated but instead continues to emit light for a predetermined time. The length of the predetermined time is dependent in particular on the magnitude of the charge state, and is stored in memory unit 148. Light-emitting element 150 is deactivated upon a transition into the working state, since the high current consumption during operation distorts the determination of the charge state by electronics system 144. Immediately subsequently to the working state, light-emitting element 150 becomes activated as a function of the charge state. In particular, subsequently to the operating state light-emitting element 150 becomes activated regardless of the motion state. Advantageously, the user can thereby immediately recognize the remaining charge directly after operation and without any actuation. If second electrical interface 110 is connected to a charging apparatus and if rechargeable battery pack 100 is being charged via the charging apparatus, light-emitting element 150 is then controlled by control unit 146 in such a way that light-emitting element 150 emits flashing green light.

Light-emitting element 150 is received within rechargeable battery pack housing 102. Rechargeable battery pack 100 has a light guide 178 in order to guide outward the light generated by light-emitting element 150. Light guide 178 is embodied from a transparent plastic. Light guide 178 is embodied in two parts, and has a first light-guiding element 180 and a second light-guiding element 182. Light guide 178 is disposed adjacently to light-emitting element 150. In particular, a gap that is as small as possible is disposed between light guide 178 and light-emitting element 150. In particular, the gap is smaller than 2 cm, preferably smaller than 1 cm, and by preference smaller than 0.5 cm. Light guide 178 has a light-collecting surface 184 that faces toward light-emitting element 150, and a light-radiating surface 186 that is disposed on the outer surface of rechargeable battery pack 100. First light-guiding element 180 has light-collecting surface 184. Second light-guiding element 182 has light-radiating surface 186. Light-collecting surface 184 extends substantially parallel to a surface over which light-emitting element 150 emits light. In particular, light-collecting surface 184 is larger than the area of light-emitting element 150. Advantageously, light-collecting surface 184 surrounds light-emitting element 150, so that the greatest possible proportion of the emitting light can be received by light-collecting surface 184.

First light-guiding element 180 is disposed in a recess of rechargeable battery pack base element 104. A sealing element 188, which protects electronics system 144 and battery cell 118 from the entry of dust or liquids, is disposed in the recess between rechargeable battery pack base element 104 and first light-guiding element 180. Sealing element 188 is embodied as a sealing ring. The sealing ring is embodied in particular from an elastic plastic. Second light-guiding element 182 is disposed in a recess of rechargeable battery pack cap 106 in such a way that light-radiating surface 186 is externally exposed. First light-guiding element 180 and second light-guiding element 182 abut against one another.

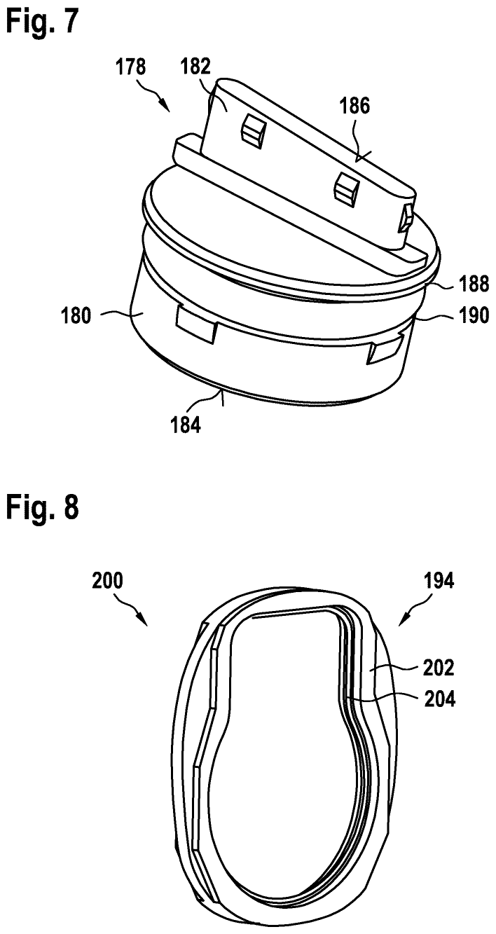

FIG. 7 is a perspective view of light guide 178. First light-guiding element 180 has an annularly encircling groove 190 in which sealing element 188 is disposed. Light-collecting surface 184 has a larger area than light-radiating surface 186. Light guide 178, in particular first light-guiding element 180, is preferably shaped in such a way that light emitted from light-emitting element 150 is at least partly concentrated toward second light-guiding element 182 or toward light-radiating surface 186.

The system made up of load 10 and rechargeable battery pack 100 preferably has a sealing apparatus 192 that protects rechargeable battery pack 100 and/or load 10 from dust and liquids. As shown in the longitudinal section of FIG. 6, the sealing apparatus encompasses, by way of example, a first sealing unit 194 and a second sealing unit 196. First sealing unit 194 and second sealing unit 196 are disposed between first electrical interface 108 and second electrical interface 110. In particular, first sealing unit 194 and second sealing unit 196 are disposed between two interface openings 198 in rechargeable battery pack housing 102. Interface openings 198 are disposed adjacently to electrical interfaces 108, 110. Electrical interfaces 108, 110 are connectable via interface openings 198 to load 10, in particular to a corresponding electrical interface 34 of handheld power tool 12, and to the charging apparatus. First and second sealing unit 194, 196 at least partly radially surround first and second electrical interface 108, 110.

A perspective view of first sealing unit 194 is shown in FIG. 8. First sealing unit 194 is made up of a two-part sealing element 200. Outer part 202 of sealing element 200 is made of a hard plastic; internal part 204 of sealing element 200 is made of a soft plastic. The two-part sealing element 200 has an internal receiving opening 206. The shape of receiving opening 206 corresponds substantially to the shape of rechargeable battery pack housing 102, in particular of rechargeable battery pack base element 104. Upon connection of rechargeable battery pack 100 to load 10, rechargeable battery pack 100 becomes inserted into rechargeable battery pack receptacle 30 of load 10. The shape of receiving opening 206 preferably corresponds substantially to the shape of rechargeable battery pack housing 102 in the front region or in the region of first electrical interface 108, and in the region in which sealing element 200 abuts against rechargeable battery pack base element 104 in the connected state. Upon connection, sealing element 200, in particular internal part 204 of sealing element 200, firstly impinges upon the front region of rechargeable battery pack housing 102. Advantageously, rechargeable battery pack housing 102 is shaped in such a way that sealing element 200 always abuts against rechargeable battery pack housing 102 between that front region and the end position in the connected state, so that dust and liquids are forced out upon connection. In particular, sealing element 200, in particular internal part 204 of sealing element 200, becomes elastically deformed by rechargeable battery pack housing 102 in order to achieve a good sealing effect. The two-part sealing element 200 is received in a housing groove 208 in housing 14 of handheld power tool 12. Second sealing unit 196 is made up of a sealing element 210 that is embodied, by way of example, as a sealing ring. The sealing ring is preferably embodied to be elastically deformable in order to ensure a good sealing effect. Sealing element 210 is, in particular, disposed between rechargeable battery pack base element 104 and rechargeable battery pack cap 106 in such a way that no dust or liquid can penetrate into the interior of rechargeable battery pack housing 102.

In the connected state, the system has a housing opening 212 that is disposed between housing 14 of handheld power tool 12 and rechargeable battery pack housing 102. Housing opening 212 is embodied as an encircling gap. Through housing opening 212, dust or liquids can enter the space between housing 14 of handheld power tool 12 and rechargeable battery pack housing 102, and the space between rechargeable battery pack base element 104 and rechargeable battery pack 106. Advantageously, it is possible to ensure by way of first sealing unit 194 that dust or liquids cannot emerge from the space between rechargeable battery pack housing 102 and housing 14 of handheld power tool 12 in a direction toward interface opening 198 of first electrical interface 108. It is also possible to ensure by way of second sealing unit 196 that dust or liquid cannot emerge from the space between rechargeable battery pack base element 104 and rechargeable battery pack cap 106 in a direction toward the interior of rechargeable battery pack housing 102.

For additional sealing of rechargeable battery pack 100, rechargeable battery pack 100 has closure elements 214, 216 that are disposed or disposable in housing openings and are sealed by way of a further sealing element 188, 220. For example, light guide 178 is disposed in a housing opening and is embodied as a closure element 214. As already described above, the housing opening in which light guide 178 is disposed is sealed by way of a further sealing element 188 embodied as a sealing ring.

Interface opening 198, which is disposed in the region of second electrical interface 110, is likewise embodied to be closable by way of a closure element 216. Closure element 216 is embodied as a movably, in particular rotatably, mounted tab. Closure element 216, embodied as a tab, is embodied from an elastic plastic. The tab is formed, in particular, from a soft plastic. Closure element 216 has a sealing region 222 which is embodied in such a way that sealing region 222 becomes compressed in interface opening 198, and thus seals interface opening 198 in the connected state. Closure element 216 is thus also embodied as a further sealing element 220.

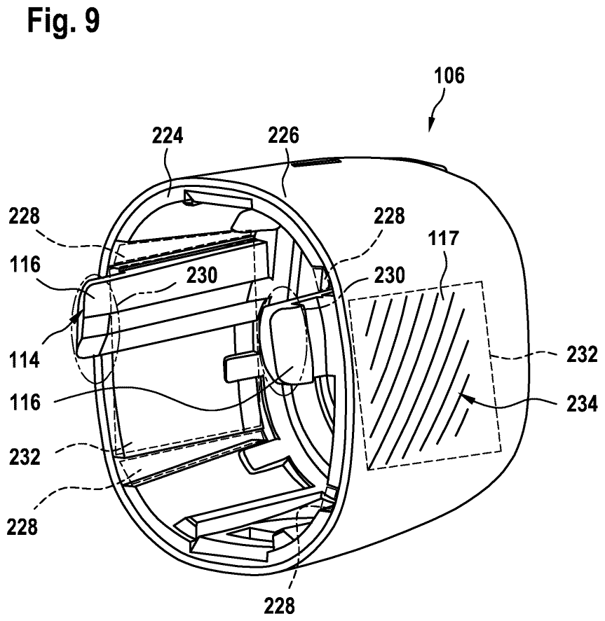

FIG. 9 is a perspective view of rechargeable battery pack cap 106. Rechargeable battery pack cap 106 is embodied in particular in two parts, and is made up of an internal housing part 224 and an external housing part 226. External housing part 226 is embodied from a soft plastic, and internal housing part 224 is embodied from a hard plastic. Rechargeable battery pack cap 106 is produced in particular using a two-component injection molding process. External housing part 226 preferably encompasses a thermoplastic elastomer (TPE). External housing part 226 is preferably made up of at least one thermoplastic elastomer. The thermoplastic elastomer can be, for example, TPC, TPO, TPS, TPU, and/or TPV. Internal housing part 224 can be embodied, by way of example, from one of the following materials: acrylonitrile-butadiene-styrene, polycarbonate, polycarbonate/acrylonitrile-butadiene-styrene, PA, PA-GF, PMMA, polypropylene, polyethylene, and/or the like. Internal housing part 224 is preferably made of polycarbonate/acrylonitrile-butadiene-styrene, and external housing part 226 of a thermoplastic elastomer.

The two latching arms 116 of mechanical interface 114 of rechargeable battery pack cap 106 are embodied in one piece with internal housing part 224. Two respective gaps 228 are disposed adjacently to latching arms 116. Gaps 228 are embodied in such a way that they increase the elasticity of latching arms 116. Gaps 228 extend substantially parallel to the longitudinal extent of rechargeable battery pack 100, or substantially parallel to the longitudinal extent of battery cell 118 received in rechargeable battery pack 100. External housing part 226 surrounds internal housing part 224, in particular, at least in such a way that gaps 228 are completely covered. Advantageously, penetration of dust and liquids into the interstice between rechargeable battery pack cap 106 and rechargeable battery pack base element 104 can thereby be minimized.

Mechanical interface 114 encompasses a coupling region 230 and an operating region 232. Coupling region 230 is embodied as a front end of latching arm 116, and extends toward load 10. Coupling region 230 is embodied as a latching hook that engages nonpositively and positively into a latching pocket 32 of load 10 in order to establish the mechanical connection between load 10 and rechargeable battery pack 100. Coupling region 230 is embodied projectingly from external housing part 226, and in the connected state is surrounded by housing 14 of handheld power tool 12. Operating region 232 is spanned in particular by at least one, preferably by at least two gaps 228. Operating region 232 encompasses an operating element 117. Operating element 117 is mechanically coupled to latching arm 116 in such a way that an application of force onto operating element 117 results in an actuation of latching arm 116. By way of an application of force onto operating region 232 from outside, latching arms 116 can be moved inward and moved out of latching pockets 32. Operating regions 232 are, in particular, arranged in such a way that they are actuatable in the state that is not connected to load 10 and in the state that is connected to load 10. Advantageously, external housing part 226 has rib-shaped operating means (operating element) 234 that on the one hand make available to the user an indication of the positioning of operating region 232, and on the other hand increase friction in operating region 232 so that the rechargeable battery pack can be securely grasped. Operating means 234 is disposed on the outer side of operating element 117.

In the state connected to load 10, internal housing part 224 is substantially completely surrounded by external housing part 226. Advantageously, if the system made up of load 10 and rechargeable battery pack 100 happens to fall, the force that acts is effectively damped by the elastic and vibration-damping softer material of external housing part 226, and rechargeable battery pack 100 is thereby protected from damage.

What is claimed is:

1. An electrical contact apparatus for a rechargeable battery pack, comprising:
a cell connector by way of which the electrical contact apparatus is electrically connectable to a battery cell;
an electrical contact by way of which the electrical contact apparatus is connectable to a load and/or to a charging apparatus; and
a flat connector configured for electrical and mechanical connection of the cell connector to the electrical contact;
wherein the cell connector is intermaterially connected in a first connecting region to the flat connector, and the flat connector is intermaterially connected in a second connecting region to the electrical contact; and
wherein at least one of the intermaterial connections is effected using a welding process.

2. The electrical contact apparatus as recited in claim 1, wherein all of the intermaterial connections are effected using the welding process.

3. The electrical contact apparatus as recited in claim 1, wherein the first connection region and the second connecting region are disposed at oppositely located ends of the flat connector.

4. The electrical contact apparatus as recited in claim 1, wherein the cell connector and the flat connector are made of the same material.

5. The electrical contact apparatus as recited in claim 4, wherein the cell connector and the flat connector are made of a copper alloy or of ultra-pure copper.

6. The electrical contact apparatus as recited in claim 1, wherein the flat connector and the electrical contact are made of different materials relative to each other.

7. The electrical contact apparatus as recited in claim 1, wherein a thickness of the flat connector in the first connecting region is greater than a thickness of the cell connector in the first connecting region.

8. The electrical contact apparatus as recited in claim 1, wherein a thickness of the electrical contact in the second connecting region is greater than a thickness of the flat connector.

9. The electrical contact apparatus as recited in claim 1, wherein the electrical contact apparatus has at least one connecting element that is embodied to partly space the flat connector away from the cell connector, or the electrical contact away from the flat connector, adjacently to the first and/or second connecting regions.

10. The electrical contact apparatus as recited in claim 9, wherein the connecting element is embodied in one piece with the electrical contact apparatus.

11. The electrical contact apparatus as recited in claim 9, wherein a width of the connecting element corresponds to at most 50% of the width of the electrical contact apparatus.

12. The electrical contact apparatus as recited in claim 9, wherein a width of the connecting element corresponds to at most 30% of the width of the electrical contact apparatus.

13. The electrical contact apparatus as recited in claim 9, wherein a width of the connecting element corresponds to at most 15% of the width of the electrical contact apparatus.

14. The electrical contact apparatus as recited in claim 9, wherein a material thickness in a region of the connecting element is decreased by at least 10%,.

15. The electrical contact apparatus as recited in claim 9, wherein a material thickness in a region of the connecting element is decreased by at least 20%.

16. A single-cell rechargeable battery pack, comprising:
a battery cell; and
an electrical contact apparatus including:
a cell connector by way of which the electrical contact apparatus is electrically connectable to the battery cell;
an electrical contact by way of which the electrical contact apparatus is connectable to a load and/or to a charging apparatus; and
a flat connector configured for electrical and mechanical connection of the cell connector to the electrical contact;
wherein the cell connector is intermaterially connected in a first connecting region to the flat connector, and the flat connector is intermaterially connected in a second connecting region to the electrical contact;
wherein at least one of the intermaterial connections is effected using a welding process; and
wherein the rechargeable battery pack has a power output of more than 120 W.

17. The battery pack as recited in claim 16, wherein the rechargeable battery pack has a power output of more than 140 W.

18. The battery pack as recited in claim 16, wherein the battery pack is for a handheld power tool.

19. A method for manufacturing an electrical contact apparatus having at least two electrically conductive components, the method comprising:
connecting the electrically conductive components to one another using a resistance welding process and/or a laser welding process.

20. The method as recited in claim 19, further comprising:
deforming at least one of the electrically conductive components by application of force to manufacture a connecting element.
